(19) United States
(12) Patent Application Publication
(10) Pub. No.: US 2013/0069606 A1
(43) Pub. Date: Mar. 21, 2013

(54) DC Converter with Adjustable Output Voltage

(71) Applicants: Christian Wachter, Darmstadt (DE); Jan Christian Langsdorf, Oberursel (DE); Gerd Laschinski, Oberursel (DE)

(72) Inventors: Christian Wachter, Darmstadt (DE); Jan Christian Langsdorf, Oberursel (DE); Gerd Laschinski, Oberursel (DE)

(21) Appl. No.: 13/588,020

(22) Filed: Aug. 17, 2012

(30) Foreign Application Priority Data
Sep. 17, 2011 (EP) 11 007 581.9

(51) Int. Cl. G05F 1/46

(52) U.S. Cl. 323/234

(57) ABSTRACT

The present invention relates to a dc converter whose output voltage is adjustable. The dc converter has
an output at which an output voltage (VOUT) may be tapped, and which has an output terminal and a reference potential terminal,
a control circuit which has a control input,
a voltage divider (R1, R2), which is connected in parallel to the output, and which has a center tap connected to the control input, and
a voltage source (DC) which is connected in series to the voltage divider (R1, R2), and whose voltage (VSET) is adjustable.

### FIELD OF THE INVENTION

The present invention relates to a dc converter with adjustable output voltage and an electrical appliance having such a dc converter.

### BACKGROUND OF THE INVENTION

DC converters with constant output voltage are known, which output voltage can be tapped between an output terminal and a reference potential terminal (ground) and is ordinarily smoothed by means of a smoothing capacitor. Such a dc converter, namely a buck converter having a choke L and a control circuit, is shown schematically in FIG. 1. The output voltage VOUT of the converter is divided by a voltage divider that has two resistors R1 and R2. The center tap of the voltage divider is connected to a control input of the control circuit. The converter is controlled by the control circuit in such a way that the voltage VFB at the control input corresponds to an internal reference voltage Vref, as a result of which the output voltage VOUT remains constant. The level of the output voltage VOUT depends on the size of the resistors R1, R2: VOUT=Vref·(1+R1/R2). In the event that the output voltage VOUT of the converter is adjustable to several different values, at least one of the resistors must be variable, or a corresponding number of switchable resistors must be provided.

### SUMMARY OF THE INVENTION

The object of the present invention is to specify a dc converter whose output voltage is easily adjustable.

The object is achieved by a dc converter having the following features:
an output at which an output voltage (VOUT) may be tapped, and which has an output terminal and a reference potential terminal,
a control circuit which has a control input, and
a voltage divider (R1, R2), which is connected in parallel to the output, and which has a center tap connected to the control input,
a voltage source (DC), which is connected in series to the voltage divider (R1, R2), the voltage (VSET) of the voltage source (DC) being adjustable.

Advantageous developments of the dc converter are specified in the dependent claims. The dc converter is in particular suitable for an electrical appliance, for example an electric shaving apparatus having a Peltier element which should be operated with a regulated, easily adjustable DC voltage.

### BRIEF DESCRIPTION OF THE DRAWINGS

The present invention is explained in the following using exemplary embodiments that are shown in the drawings:

FIG. 1 schematically shows a known buck converter;

FIG. 2 shows a dc converter with infinitely adjustable output voltage;

FIG. 3 shows a variant of the dc converter according to FIG. 2.

### DETAILED DESCRIPTION OF THE INVENTION

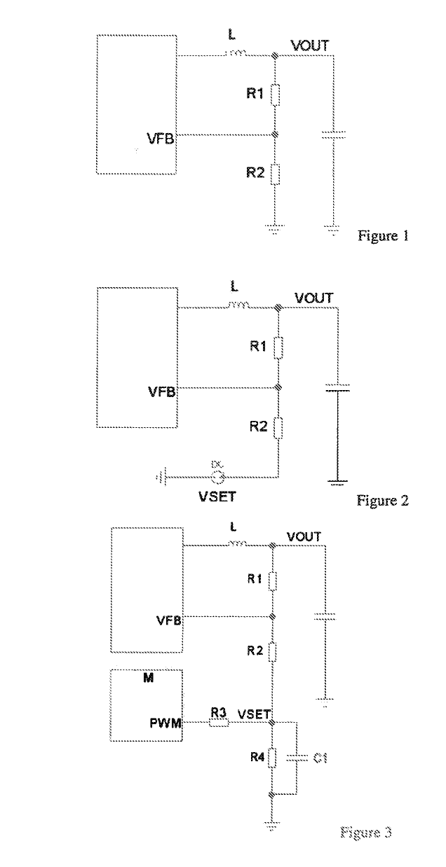

FIG. 2 shows a dc converter whose output voltage is adjustable. The converter has a buck converter known per se, as is shown in FIG. 1 and described above. However, it additionally includes a direct voltage source DC which is connected in series with the voltage divider R1, R2, that is, between the control input of the control circuit and the reference potential. The direct voltage source supplies an adjustable voltage VSET. The voltage VSET is preferably infinitely adjustable. The output voltage VOUT of the converter is dependent on the voltage VSET of the voltage source:

VOUT=Vref·(1+R1/R2)−VSET·R1/R2; wherein VSET<Vref.

Therefore the output voltage VOUT may be adjusted by appropriate selection of VSET.

The dc converter shown in FIG. 3 largely corresponds to the direct current voltage converter shown in FIG. 2; however, the direct voltage source includes an RC circuit and a generator M which feeds a pulse-width modulated voltage PWM to the RC circuit. The RC circuit has a capacitor C1 which is connected in series with the voltage divider R1, R2. The junction of the capacitor C1 and the voltage divider is linked by way of a resistor R3 to the output of the generator M. The direct voltage VSET appears at the capacitor C1 of the RC circuit; the direct voltage VSET is dependent on the pulse width of the pulse-width modulated voltage PWM and thus may be adjusted by varying the pulse width. The pulse width is preferably adjusted digitally, although analog adjustment is also possible, thereby making the pulse width practically infinitely adjustable. Connected in parallel to the capacitor C1 is a resistor R4 via which the level of the pulse-width modulated voltage PWM is lowered by a factor of R3/R4, resulting in a finer adjustability of the direct voltage VSET given the same resolution of the pulse-width modulation.

The generator M for the pulse-width modulated voltage is preferably implemented in a microcontroller. It is particularly advantageous if the control circuit for the dc converter is also implemented in the microcontroller.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dc converter with
an output at which an output voltage (VOUT) is tappable, and which output has an output terminal and a reference potential terminal,
a control circuit which has a control input and
a voltage divider (R1, R2), which is connected in parallel to the output, and which has a center tap connected to the control input,
wherein
the dc converter also has a voltage source (DC) which is connected in series to the voltage divider (R1, R2) and whose voltage (VSET) is adjustable.

2. The dc converter according to claim 1, wherein
the voltage source (DC) is connected between the control input of the control circuit and the reference potential terminal.

3. The dc converter according to claim 1, wherein the voltage source (DC) is composed of an RC circuit (R3, C1) and a generator (M), which generator (M) generates a pulse-width modulated voltage (PWM) whose pulse width is adjustable.

4. The dc converter according to claim 3, wherein the capacitor (C1) of the RC circuit (R3, C1) is connected in series between the voltage divider (R1, R2) and the reference potential terminal.

5. The dc converter according to claim 4, wherein
the resistor (R3) of the RC circuit (R3, C1) is connected between the output of the generator (M) and to the junction between the voltage divider (R1, R2) and the capacitor (C1).

6. The dc converter according to claim 4, wherein
an additional resistor (R4) is connected in parallel to the capacitor (C1) of the RC circuit (R3, C1).

7. The dc converter according to claim 3, wherein the generator (M) is implemented in a microcontroller.

8. An electrical appliance, having a dc converter according to claim 1.

9. The electrical appliance according to claim 8, wherein the appliance also has a Peltier element that is operated with the output voltage (VOUT) of the dc converter.

10. An electrical appliance according to claim 8 wherein the appliance comprises an electric shaving apparatus.
